(19) United States
(12) Patent Application Publication
(10) Pub. No.: US 2012/0076264 A1
(43) Pub. Date: Mar. 29, 2012

(54) Portable radiation imaging system

(75) Inventors: Yasunori Ohta, Kanagawa (JP); Naoyuki Nishino, Kanagawa (JP); Yusuke Kitagawa, Kanagawa (JP); Noriaki Ida, Kanagawa (JP); Tetsuro Kusunoki, Kanagawa (JP); Takeshi Kamiya, Kanagawa (JP)

(73) Assignee: FUJIFILM Corporation, Tokyo (JP)

(21) Appl. No.: 13/137,700

(22) Filed: Sep. 6, 2011

(30) Foreign Application Priority Data
Sep. 28, 2010 (JP) 2010-217401

(51) Int. Cl. G01N 23/04

(52) U.S. Cl. 378/62

(57) ABSTRACT

An X-ray imaging system includes an X-ray generator, an electronic cassette, a holder arm, a PC, and a control device. The holder arm has an L-shaped arm body and a base column. To one end of the arm body, an X-ray source is attached. The base column is perpendicularly attached to the electronic cassette, and swingably holds the arm body. The X-ray source is shifted among an R irradiation position, an L irradiation position, and a base position by the swing of the arm body, and is fixed at each position. With the shift of the X-ray source between the R and L irradiation positions, a parallax image including a pair of R and L viewpoint images is captured.

### BACKGROUND OF THE INVENTION

1. Field of the Invention

The present invention relates to a portable radiation imaging system for radiography.

2. Description Related to the Prior Art

In a medical field, an X-ray imaging system using X-rays as a kind of radiation is employed to carry out image diagnosis. The X-ray imaging system is constituted of an X-ray source for applying the X-rays to a patient's body part to be imaged, and an X-ray image detector for detecting an X-ray image upon reception of the X-rays passed through the body part. There are proposed various types of X-ray imaging systems including a portable type, which allows radiography at the bedside of a home-care patient or at a site needing emergency medical treatment e.g. an accident or natural disaster scene.

For example, Japanese Patent Laid-Open Publication No. 11-299773 discloses a movable X-ray imaging apparatus. In this apparatus, a support column erected on a carriage is provided with an approximately C-shaped holder arm for holding an X-ray source and an X-ray image detector in an opposed manner. The holder arm is rotatable on the support column, and the rotation of the holder arm changes the position and the direction of the X-ray source and the X-ray image detector. This apparatus easily achieves relative positioning between the X-ray source and the X-ray image detector in accordance with a patient's body part to be imaged by the rotation of the holder arm. Additionally, this apparatus can perform panoramic radiography. In the panoramic radiography, plural images are taken with changing an X-ray irradiation position, and the taken images are stitched together to obtain a longitudinal panoramic image.

U.S. Pat. No. 7,810,994 (corresponding to Japanese Patent Laid-Open Publication No. 2010-057546) discloses a portable X-ray imaging apparatus including a stepladder-shaped X-ray source unit and an electronic cassette being a portable X-ray image detector. The stepladder-shaped X-ray source unit is constituted of two U-shaped support legs rotatably connected at their upper ends by a hinge, and an X-ray source provided on the hinge. The X-ray source unit is erected with spreading the support legs during use, while it is made compact with folding up the support legs during carriage.

Japanese Patent Laid-Open Publication No. 10-225450 discloses a movable X-ray diagnostic apparatus having an approximately C-shaped holder arm, which is similar to that of the Japanese Patent Laid-Open Publication No. 11-299773. In this apparatus, movable parts used for positioning of the holder arm are individually provided with an electromagnetic brake. The electromagnetic brakes are released by switches provided on a handle of an X-ray generator. During surgery, a surgeon performs the optimal positioning of the holder arm by himself/herself by operating the switches, such that a focus direction of the X-ray generator coincides with a parallax direction of the surgeon. Thereby, a patient's body part to be operated is stereoscopically displayed on a monitor just in the direction of a surgeon's view.

The movable X-ray imaging apparatus according to the Japanese Patent Laid-Open Publication No. 11-299773 is moved by the carriage. This apparatus is suited for use in a hospital, but not suited for use at the bedside of the home-care patient or at the accident or natural disaster scene in terms of portability. Worse yet, this apparatus cannot perform stereoscopic X-ray imaging.

The apparatus according to the U.S. Pat. No. 7,810,994 is superior in portability, but cannot perform the stereoscopic X-ray imaging.

The apparatus according to the Japanese Patent Laid-Open Publication No. 10-225450 requires the provision of the electromagnetic brakes to the individual movable parts and the provision of the switches for operating the brakes, resulting in complicated apparatus configuration. Moreover, this apparatus requires structure sturdy enough to support the holder arm in a carriage, a support column, and the like. In addition to the carriage and the support column, the holder arm itself has to be sturdy enough to hold both the X-ray source and the X-ray image detector, as with the apparatus of the Japanese Patent Laid-Open Publication No. 11-299773. Accordingly, the apparatus becomes large and heavy, and necessarily compromises portability. Therefore, this apparatus cannot be easily used at the bedside of the home-care patient or the emergency accident or natural disaster scene.

Note that, first-aid treatment is primarily carried out at the bedside or the emergency scene. Thus, portability, settability, and compactness are essentially required of a system, rather than image accuracy. The conventional large and heavy apparatuses as described above are unsuited for this application.

### SUMMARY OF THE INVENTION

An object of the present invention is to provide a portable radiation imaging system that is superior in portability and can perform stereoscopic radiography.

To achieve the above and other objects, a portable radiation imaging system according to the present invention includes a radiation source, a portable electronic cassette, a portable holder arm, and a positioning mechanism. The radiation source applies radiation to an object. The portable electronic cassette has a radiation image detector and a case for containing the radiation image detector. The case is formed with an incident surface upon which the radiation is incident. The radiation image detector detects a radiographic image of the object upon reception of the radiation that is passed through the object and is incident upon the incident surface of the case. The portable holder arm holds the radiation source such that the radiation source is opposed to the incident surface, and shifts the radiation source between an R irradiation position and an L irradiation position. A pair of R viewpoint image and L viewpoint image having a stereoscopic parallax is obtained with a shift of the radiation source between the R and L irradiation positions. The positioning mechanism fixes the radiation source at the R and L irradiation positions.

The holder arm preferably has an arm body and a base column. The radiation source is attached to the arm body, and the arm body is movably attached to the base column. The radiation source is selectively shifted between the R and L irradiation positions by a motion of the arm body. The positioning mechanism regulates the motion of the arm body to fix a position of the radiation source. The arm body may pivot about its one end opposite to the other end having the radiation source attached thereto, in a plane parallel with the incident surface, in order to shift the radiation source between the R and L radiation positions. Furthermore, in the arm body, a length between the end functioning as a pivot and an attachment position of the radiation source may be a half of the stereoscopic parallax. In this case, the arm body turns by 180 degrees to shift the radiation source from one of the R and L irradiation positions to the other. The arm body may have an inclination mechanism for attaching the radiation source in such a manner that a radiation emission direction is inclined toward the pivot.

In another case, the portable holder arm may have an arm body and a base column. The radiation source is attached to one end of the arm body, and the base column is coupled to the other end of the arm body. The base column is disposed near the electronic cassette and swings in a plane orthogonal to the incident surface. The positioning mechanism may regulate a swing of the base column to fix a position of the radiation source.

The positioning mechanism preferably fixes the radiation source at a base position being a midpoint between the R and L irradiation positions.

The holder arm preferably includes a height adjusting mechanism for adjusting a height of the radiation source from the incident surface, and a horizontal position adjusting mechanism for adjusting a position of the radiation source in a direction parallel with the incident surface.

The portable holder arm may be detachably attached to the case, or may include a tripod. In a case where the portable holder arm includes the tripod, the portable radiation imaging system preferably further includes a level provided on each of the portable holder arm and the case, a tripod level adjuster, and a case level adjuster. The tripod level adjuster is provided in the tripod to adjust a posture of the tripod such that the radiation source is coplanar and horizontal at the R and L irradiation positions. The case level adjuster is provided in the case to adjust a posture of the case such that the incident surface is horizontal without wobbling.

The portable radiation imaging system according to the present invention includes the portable holder arm, which shifts the radiation source between the R and L irradiation positions. Thereby, it is possible to easily obtain the R and L viewpoint images having the stereoscopic parallax.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a perspective view of a portable X-ray imaging system according to a first embodiment;

FIG. 2 is an exploded perspective view of a positioning mechanism provided inside a base column;

FIG. 3 is a block diagram of a FPD contained in an electronic cassette;

FIG. 4 is a top plan view of a holder arm and an electronic cassette according to a second embodiment;

FIG. 5 is a side view of the holder arm and the electronic cassette according to the second embodiment;

FIG. 6 is a top plan view of an electronic cassette and a characteristic portion of a holder arm according to a third embodiment;

FIG. 7 is a side view of the electronic cassette and the characteristic portion of the holder arm according to the third embodiment;

FIG. 8 is a perspective view of a holder arm and an electronic cassette according to a fourth embodiment; and

FIG. 9 is a side view of the holder arm and the electronic cassette according to the fourth embodiment.

### DESCRIPTION OF THE PREFERRED EMBODIMENTS

### First Embodiment

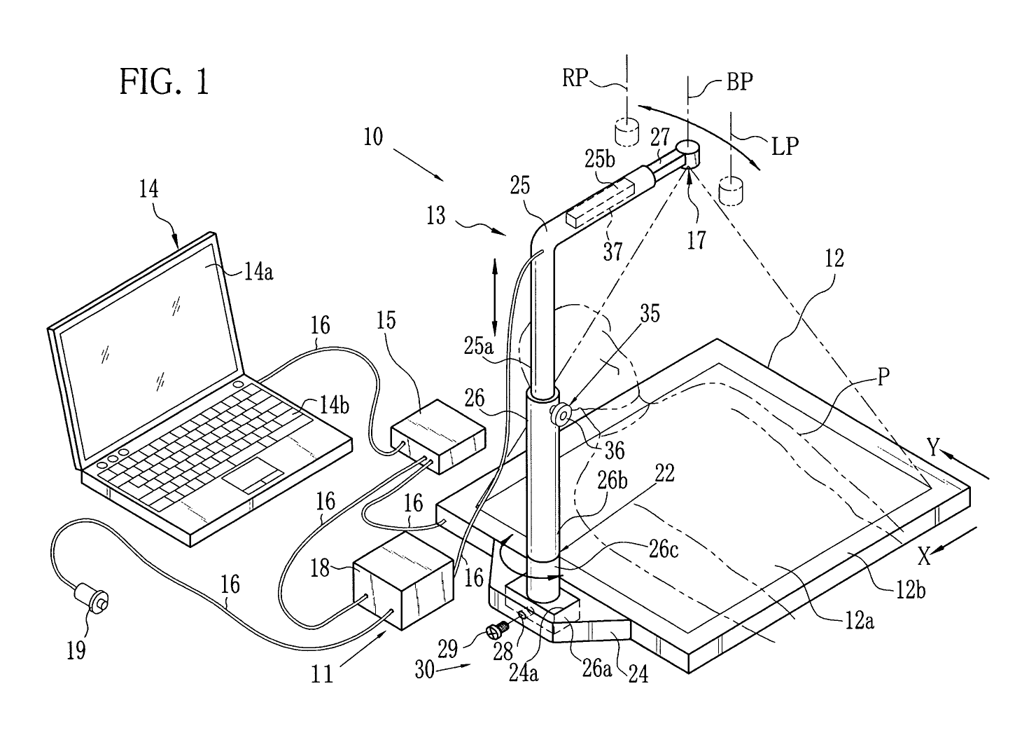

Referring to FIG. 1, an X-ray imaging system 10 according to a first embodiment of the present invention is a portable system suited for use in the bedside of a home-care patient or an emergency accident or natural disaster scene. The X-ray imaging system 10 is constituted of an X-ray generator 11, an electronic cassette 12, a holder arm 13, a notebook PC (hereinafter simply called PC) 14, a control device 15, and cables 16 for connecting all the above mentioned components.

The X-ray generator 11, the electronic cassette 12, the holder arm 13, the PC 14, and the control device 15 are carried along separately to the bedside or the emergency scene. At the desired location, the components are easily assembled into the X-ray imaging system 10 by connecting the cables 16 and the like, as a preparation for X-ray imaging.

The X-ray generator 11 includes an X-ray source 17, a high voltage generator 18 for supplying high voltage to the X-ray source 17, and an irradiation switch 19. The X-ray source 17 is constituted of an X-ray tube and a collimator (neither is shown). The X-ray tube includes a cathode for emitting electrons, and an anode for generating X-rays upon collision with the electrons. The collimator limits an irradiation field of the X-rays, which radiate from a focus of the X-ray tube. The collimator has such a configuration that two pairs of lead plates for shielding the X-rays are arranged into the shape of a number sign “#” at right angles with leaving a light transmitting opening in the middle, for example. Movement of the lead plates changes the size of the light transmitting opening for passing the X-rays, and limits the irradiation field of the X-rays.

As the X-ray tube, a small fixed anode X-ray tube is used, as described in Japanese Patent No. 3090910. The fixed anode X-ray tube can be small in size because of eliminating the need for providing an anode rotating mechanism, though a rotary anode X-ray tube needs the mechanism.

As described in the Japanese Patent No. 3090910, the X-ray tube preferably has a cold cathode. The X-ray tube with the cold cathode can be smaller in size because of eliminating the need for providing a filament and a heater, though an X-ray tube with a hot cathode needs the filament and the heater to eject thermoelectrons from the filament heated by the heater. Additionally, since time for preheating the filament becomes unnecessary, the X-ray tube with the cold cathode quickly starts emitting the X-rays and offers high convenience especially in case of emergency. As a kind of the X-ray tube with the cold cathode, for example, there is an ultrasmall X-ray tube using carbon nanostructure as a cold cathode and a dry battery as a power source, developed by AIST (National Institute of Advanced Industrial Science and Technology). Out of various types of X-ray tubes with the cold cathode, such an ultrasmall X-ray tube is preferably used.

The high voltage generator 18 is connected to the X-ray source 17 through the cable 16, and supplies high voltage to the X-ray source 17. More specifically, the high voltage generator 18 supplies electric energy to the X-ray source 17 in accordance with imaging conditions, including a tube voltage, a tube current, and irradiation time, provided from the control device 15 to determine energy of the X-rays to be emitted. To the high voltage generator 18, the irradiation switch 19 is connected to input an irradiation start command. In response to the irradiation start command outputted upon a press of the irradiation switch 19, the high voltage generator 18 starts supplying the electric energy to the X-ray source 17. An irradiation start signal triggered by the press of the irradiation switch 19 is transferred from the high voltage generator 18 to the control device 15.

Upon receiving the irradiation start signal from the high voltage generator 18, the control device 15 notifies the electronic cassette 12 of a start of X-ray emission, and synchronizes operation between the X-ray source 17 and the electronic cassette 12. The control device 15 transfers the imaging conditions inputted from the PC 14 to the high voltage generator 18 and the electronic cassette 12.

Various software programs are installed in the PC 14, including a program for setting up the imaging conditions, a program for applying image processing to image data received from the electronic cassette 12 and displaying the processed image data on a monitor 14a of the PC 14, and the like. The PC 14 functions as a console of the X-ray imaging system 10. In setting up the imaging conditions on the PC 14, an imaging menu screen is displayed on the monitor 14a to select an appropriate imaging item in accordance with a body part to be imaged, such as chest or abdomen. When the appropriate imaging item is selected with operating an operation panel 14b including a keyboard, a mouse, and the like, the corresponding imaging conditions are set up.

The X-ray imaging system 10 can perform stereoscopic radiography, namely obtain a stereo image for stereoscopy, as will be described in detail later on. When a stereoscopic radiography mode is selected, the PC 14 stores a pair of R and L viewpoint images in an associated manner as a single parallax image. There are some known methods for the stereoscopy, including a method using active shutter glasses, a method using polarizing glasses, and an integral imaging method without using glasses, and any method is adoptable. The PC 14 displays the parallax image on the monitor 14a in a way corresponding to the adopted method.

The electronic cassette 12 has an FPD 39 (see FIG. 3) and a flat case 12b containing the FPD 39. The FPD 39, being an X-ray image detector, detects an X-ray image upon reception of the X-rays that have been emitted from the X-ray source 17 and have passed through the patient's body part (object) to be imaged. The case 12b has an incident surface 12a at one surface on which the X-rays are incident. The case 12b is constituted of a frame and a transparent plate. The frame is made of an X-ray shielding material such as stainless, and has an opening in a portion corresponding to the incident surface 12a. The transparent plate is made of an X-ray transparent material such as carbon, and is fitted onto the opening to form the incident surface 12a. The case 12b is approximately in the shape of a rectangle plate. On one side of the case 12b, a grip 24 is provided to improve portability. The grip 24 has an opening 24a so that a carrier securely holds the grip 24 with his/her fingers.

The holder arm 13 holds the X-ray source 17 movably in a plane parallel to the incident surface 12a. The holder arm 13 situates the X-ray source 17 directly above the incident surface 12a with leaving space for a patient P lying down.

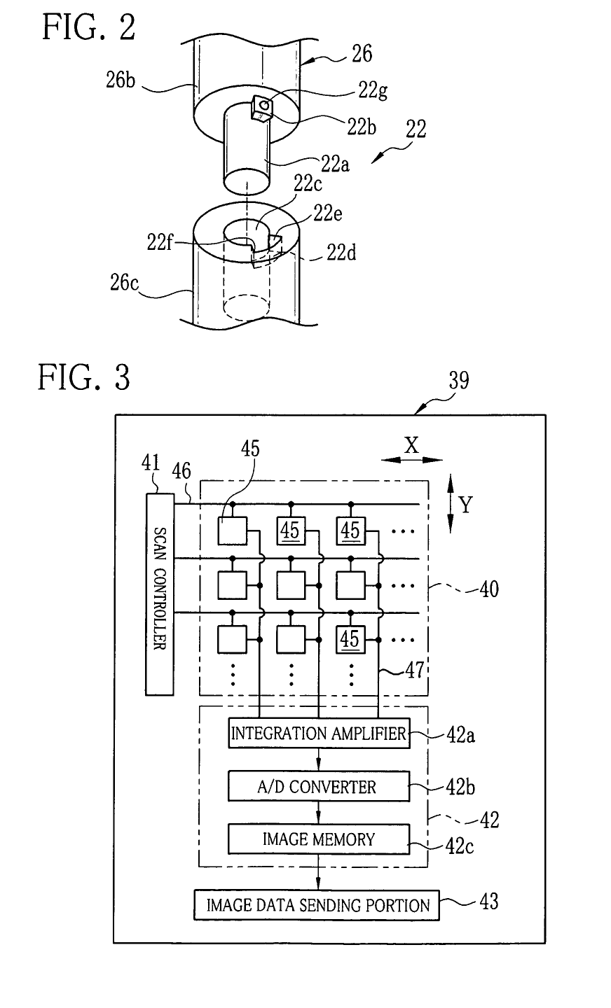

The holder arm 13 is constituted of an arm body 25 and a base column 26. The arm body 25 has the X-ray source 17 at its one end. The base column 26 holds the arm body 25 swingably in the plane parallel to the incident surface 12a. The base column 26 is perpendicularly disposed near the electronic cassette 12. Inside the base column 26, a swing shaft 22a (see FIG. 2) is formed. The swing shaft 22a facilitates swinging of the arm body 25 attached to the base column 26.

The base column 26 is provided with a positioning mechanism 22. The positioning mechanism 22 is composed of an upper column 26b and a lower column 26c into which the base column 26 is divided in its perpendicular direction. The positioning mechanism 22 situates the X-ray source 17 at each of an R (right-eye) irradiation position RP and an L (left-eye) irradiation position LP in the stereoscopic radiography mode, in order to obtain the parallax image including the pair of R and L viewpoint images for the stereoscopy. Note that, the R viewpoint image is obtained with the X-rays emitted from the X-ray source 17 at the R irradiation position RP. The L viewpoint image is obtained with the X-rays emitted from the X-ray source 17 at the L irradiation position LP.

As shown in FIG. 2, the swing shaft 22a is formed at the center of the upper column 26b. On a periphery of the swing shaft 22a, a projection 22b is formed. The lower column 26c is provided with a bearing hole 22c for rotatably holding the swing shaft 22a, and a sector-shaped regulating groove 22d formed on the periphery of the bearing hole 22c to regulate motion of the projection 22b. The regulating groove 22d is formed with a first regulating end 22e and a second regulating end 22f. The first regulating end 22e regulates swing motion of the arm body 25 in a first direction, so as to set the X-ray source 17 at the R irradiation position RP. The second regulating end 22f regulates the swing motion of the arm body 25 in a second direction opposite to the first direction, so as to set the X-ray source 17 at the L irradiation position LP.

A click stop mechanism is provided between an outer periphery of the projection 22b and an inner periphery of the regulating groove 22d. To be more specific, the click stop mechanism is constituted of a ball stopper 22g disposed on the outer periphery of the projection 22b with being biased outward by a coil spring contained therein, and pits formed in the inner periphery of the regulating groove 22d. The click stop mechanism fixes the projection 22b at positions corresponding to the R irradiation position RP, the L irradiation position LP, and a midpoint (base position BP) between the R and L irradiation positions RP and LP. The click stop mechanism facilitates proper positioning of the X-ray source 17 in the stereoscopic radiography mode. In particular, when the X-ray source 17 is fixed at the base position BP being the midpoint between the R and L irradiation positions RP and LP, relative positioning between the X-ray source 17 and the patient's body part to be imaged is easily achieved.

Referring to FIG. 1, the base position BP is an initial position of the X-ray source 17 attached to the holder arm 13. The X-ray source 17 is situated in the base position BP in a normal radiography mode. The base position BP is so determined that the center of the irradiation field of the X-ray source 17 coincides with the center of the incident surface 12a of the case 12b, when the holder arm 13 is attached to the grip 24 of the case 12b. In other words, when the holder arm 13 is attached to the case 12b, if the X-ray source 17 is situated in the base position BP, the center of the irradiation field of the X-ray source 17 coincides with the center of the incident surface 12a. Note that, the distance between the R and L irradiation positions RP and LP is 40 cm, for example, but is not limited thereto.

The arm body 25 is formed into the shape of the letter L with a vertical portion 25a and a horizontal portion 25b. The vertical portion 25a is fitted onto an upper end of the base column 26 slidably in a vertical direction. At an end of the horizontal portion 25b, the X-ray source 17 is detachably attached through an attachment pipe 27 in a slidable manner in a horizontal direction. The horizontal portion 25b contains a click stopper 37. When the electronic cassette 12 is exchanged with another one having an incident surface 12a of a different size, the click stopper 37 moves the X-ray source 17 in an X direction to each individual base position, which varies depending on the size of the incident surface 12a, in order to quickly shift the center of the irradiation field. The click stopper 37 fixes the X-ray source 17 on each individual base position. The horizontal portion 25b and the click stopper 37 function as a horizontal position adjusting mechanism, which shifts the X-ray source 17 in a direction parallel to the incident surface 12a to adjust the position of the X-ray source 17 in the horizontal direction.

The base column 26 is provided with a fitting portion 26a at its bottom end. The fitting portion 26a has a shape corresponding with the shape of the opening 24a of the grip 24 of the electronic cassette 12. By fitting the fitting portion 26a into the opening 24a, the base column 26 is attached to the electronic cassette 12 perpendicularly to the incident surface 12a of the case 12b. The holder arm 13 is detachably attached to the case 12b by fitting the fitting portion 26a into the opening 24a of the grip 24.

The grip 24 has a screw hole 28, which penetrates to the opening 24a. Into the screw hole 28, a lock screw 29 is fastened. When the lock screw 29 is fastened into the screw hole 28, a tip end of the screw hole 29 is engaged in the fitting portion 26a, and prevents the base column 26 from slipping off from the opening 24a of the grip 24. The screw hole 28 and the lock screw 29 compose a base locking mechanism 30.

Since the holder arm 13 is attached to the case 12b, the case 12b functions as a mount to support the holder arm 13, and thereby the holder arm 13 has a simple configuration. The weight and shape of the holder arm 13 and the case 12b are determined such that the holder arm 13 is kept stably erect in the state of being attached to the case 12b. Additionally, since the patient P lies down on the incident surface 12a of the electronic cassette 12 when taking an image, the weight of the patient P facilitates striking a balance to keep the holder arm 13 in an erect state. This further improves stability of the holder arm 13. Furthermore, the positive use of the weight of the patient P as a balancing weight eliminates the need for providing a heavy electronic cassette as the mount, and hence improves portability.

Each of the arm body 25 and the base column 26 is in a tubular shape. The vertical portion 25a of the arm body 25 and the base column 26 are slidable relative to the other without idling through a not-shown rotation regulating member (for example, a key and a key groove). At this slide portion, a height adjusting mechanism 35 having a rack and a pinion (neither is shown) is provided. The height adjusting mechanism 35 is constituted of the pinion attached to the base column 26, the rack attached to the arm body 25, and a dial 36 for turning the pinion. A turn of the dial 36 rotates the pinion, and thus moves up or down the rack engaging with the pinion, or equivalently, moves up or down the arm body 25. The dial 36 is provided with a stopper (not shown) to hold the arm body 25 at an arbitrary or predetermined height position. The height adjusting mechanism 35 allows a change in an SID (source image distance), being the distance between the incident surface 12a and the X-ray source 17.

In most cases, a maximum projection angle of the X-ray source 17 limited by the light transmitting opening of the collimator, that is, an apex angle of an isosceles triangle that the focus of the X-ray tube as the apex forms with a line connecting both ends of the light transmitting opening as a base is approximately 12°. In the case of changing the irradiation field of the X-rays without changing the size of the light transmitting opening, the SID is changed by moving the arm body 25 up or down.

As shown in FIG. 3, the FPD 39 converts the X-rays into an electric signal to produce image data. The FPD 39 is constituted of an imaging section 40, a scan controller 41, a signal converter 42, and an image data sending portion 43. The imaging section 40 includes a plurality of detection elements 45, which compose pixels, arrayed on an active matrix substrate in two dimensions along X and Y directions. The imaging section 40 is laid out in a position corresponding to the incident surface 12a inside the case 12b, such that the center of the imaging section 40 coincides with the center of the incident surface 12a. The detection elements 45 convert the X-rays into electric charges, and accumulate the electric charges. The scan controller 41 controls readout timing of the electric charges from the imaging section 40. The signal converter 42 successively reads out the electric charges accumulated in the detection elements 45 of the imaging section 40. The signal converter 42 converts the electric charges into the image data, and stores the image data. The image data sending portion 43 transmits the image data to an image processor of the PC 14. Note that, the imaging section 40 is in the shape of a square of approximately 43 cm by 43 cm, for example. An arrangement pitch of the detection elements 45 is approximately 200 μm in each of the X and Y directions.

The detection elements 45 are connected on a row-by-row basis to the scan controller 41 with scan lines 46. The detection elements 45 are also connected on a column-by-column basis to the signal converter 42 with signal lines 47. Note that, the X direction corresponds to a row direction, while the Y direction corresponds to a column direction.

The detection element 45 is of a direct conversion type, in which a conversion layer made of amorphous selenium (a-Se) and the like directly converts the X-rays into the electric charges, and the converted electric charges are accumulated in a capacitor connected to an electrode situated under the conversion layer. The amount of the converted electric charges corresponds to the amount of the incident X-rays. To each detection element 45, a TFT switch (not shown) is connected. More specifically, a gate electrode of the TFT switch is connected to the scan line 46. A source electrode of the TFT switch is connected to the capacitor. A drain electrode of the TFT switch is connected to the signal line 47.

While the X-ray source 17 is emitting the X-rays, the TFT switches are turned off, and the detection elements 45 accumulate signal charges by amounts corresponding to the amounts of the incident X-rays. When emission of the X-rays is completed, the scan controller 41 sequentially supplies drive pulses to each scan line 46 on a row-by-row basis. Since the TFT switches are turned on in response to the drive pulses, the signal charges accumulated in the capacitors are outputted to the signal lines 47.

The signal converter 42 includes an integration amplifier 42a, an A/D converter 42b, and an image memory 42c. The integration amplifier 42a integrates the electric charges of each signal line 47 to convert the electric charges into a voltage signal (image signal), and inputs the image signal to the A/D converter 42b. The A/D converter 42b converts the inputted image signal into digital image data, and inputs the image data to the image memory 42c.

In this embodiment, the FPD 39 of direct conversion type is used, which has the conversion layer for directly converting the X-rays into the electric charges. However, an indirect conversion type of FPD may be used instead. In the indirect conversion type of FPD, a phosphor (scintillator) such as gadolinium oxysulfide (GOS) or cesium iodide (CsI) temporarily converts the X-rays into visible light, and photo diodes convert the visible light into electric charges.

The operation of the X-ray imaging system 10 will be hereinafter described. The X-ray imaging system 10 is stored in such a state that the X-ray source 17, the holder arm 13, and the electronic cassette 12 are disassembled. In the case of using the X-ray imaging system 10 at the bedside of the home-care patient or a site needing emergency medical treatment, the disassembled X-ray source 17, holder arm 13, and electronic cassette 12 are carried along as unvoluminous parts for convenience of portability. Additionally, the PC 14, the control device 15, and the cables 16 are carried along together.

At a desired location, the X-ray imaging system 10 is set up in preparation for radiography. As shown in FIG. 1, the X-ray source 17 is attached to the holder arm 13. The base column 26 of the holder arm 13 is fitted into the opening 24a of the grip 24 of the electronic cassette 12, and is then fixed by the lock screw 29. Thereby, the X-ray source 17 and the electronic cassette 12 are integrated such that the X-ray source 17 is opposed to the incident surface 12a of the case 12b. Subsequently, the electronic cassette 12, the PC 14, the control device 15, the X-ray source 17, the high voltage generator 18, and the irradiation switch 19 are connected through the cables 16.

After completion of the setup of the X-ray imaging system 10, the positioning between the patient P and the electronic cassette 12 is performed. A posture of the patient P is corrected such that the body part to be imaged of the patient P is situated on the incident surface 12a. Since the electronic cassette 12 and the X-ray source 17 are integrated in an opposed manner via the holder arm 13, all an operator has to do is to adjust the position between the patient P and the electronic cassette 12. Thereby, the position between patient P and the X-ray source 17 is adjusted by itself. Accordingly, it is possible to easily perform the positioning between the electronic cassette 12 and the X-ray source 17, when compared with a system having an electronic cassette and an X-ray source used in a separate manner as described in U.S. Pat. No. 7,810,994.

When the holder arm 13 is attached, if the attachment pipe 27 is set at the corresponding base position BP, the center of the irradiation field of the X-ray source 17 coincides with the center of the incident surface 12a. This facilitates the positioning between the patient's body part to be imaged and the electronic cassette 12. Especially, when the patient P lies down on the incident surface 12a of the electronic cassette 12, the patient's body covers the incident surface 12a, and makes the center of the incident surface 12a invisible. According to this embodiment, however, the operator can guess from the position of the X-ray source 17 where the center of the incident surface 12a is positioned, even if the patient's body covers the incident surface 12a. Thus, it is possible to easily situate the patient's body part to be imaged on the center of the incident surface 12a.

As a matter of course, the X-ray source 17 may be provided with a sight unit, which visualizes the irradiation field of the X-rays on the patient's body by applying illumination light such as a laser beam, as in the case of a stationary X-ray source. The X-ray imaging system 10 according to the present invention does not necessarily need the sight unit, and is effective at miniaturizing the X-ray source 17.

To adjust the horizontal position of the X-ray source 17, the attachment pipe 27 is slid. To change the size of the irradiation field, the arm body 25 is moved up or down to adjust the height of the X-ray source 17, in addition to adjustment of the light transmitting opening of the collimator. As described above, the X-ray source 17 can be moved, while the holder arm 13 remains attached to the case 12b. This allows the easy positioning of the patient's body part to be imaged.

When the positioning is completed, the operator inputs the imaging conditions from the operation panel 14b of the PC 14 in accordance with the body part to be imaged. The PC 14 sets up the imaging conditions on the high voltage generator 18 and the electronic cassette 12 via the control device 15. Then, the preparation for the radiography is completed.

When the operator presses the irradiation switch 19 after the completion of the preparation, the X-ray source 17 emits the X-rays. The X-rays pass through the patient's body part to be imaged, and are incident upon the incident surface 12a. Thus, the FPD 39 detects a radiographic image of the patient's body part. The FPD 39 outputs the image to the PC 14. The PC 14 applies the image processing to the image, and displays the processed image on the monitor 14a. The single radiographic image is obtained in this manner. In continuously taking a radiographic image of another body part, the positioning between the X-ray source 17 and the body part to be imaged is re-performed by changing the posture of the patient P and/or changing the horizontal position of the X-ray source 17 by the slide of the attachment pipe 27.

In performing the stereoscopic radiography, the stereoscopic radiography mode is selected on the operation panel 14b of the PC 14. After the change into the stereoscopic radiography mode, the arm body 25 is turned in a counterclockwise direction so as to set the X-ray source 17 at the R irradiation position RP, and the R viewpoint image is captured. After that, the arm body 25 is turned in a clockwise direction so as to set the X-ray source 17 at the L irradiation position LP, and the L viewpoint image is captured. Since the positioning mechanism 22 secures the X-ray source 17 at each of the R and L irradiation positions RP and LP, the positioning of the X-ray source 17 is easily achieved in the stereoscopic radiography. The electronic cassette 12 outputs to the PC 14 the R and L viewpoint images captured with the X-ray source 17 being set at the R and L irradiation positions RP and LP, respectively. The PC 14 stores a pair of R and L viewpoint images captured in the stereoscopic radiography mode in an associated manner as the single parallax image. Then, the PC 14 produces a stereo image compliant with an adopted stereoscopic method, and displays the stereo image on the monitor 14a. Thus, a region of interest can be observed through the stereoscopy.

In the first embodiment, the arm body 25 is turned in the plane parallel to the incident surface 12a. Thus, the SID is always kept constant, while both of the R and L viewpoint images for the stereoscopy are captured. Since the stereo image is produced from these R and L viewpoint images, the stereo image becomes natural and realistic.

In this embodiment, the X-ray source 17 is set at a predetermined position above the electronic cassette 12 only by fitting the base column 26 into the opening 24a of the grip 24 of the electronic cassette 12. This makes the positioning simple and easy in the radiography. The X-ray imaging system 10 can be disassembled into three main components, that is, the holder arm 13 having the X-ray source 17, the electronic cassette 12, and the PC 14, and hence carried along with ease. These components may be transported separately or together with being packed in a bag, a box, or the like as a matter of course.

Since the holder arm 13 is attached to the electronic cassette 12 using the opening 24a of the grip 24, it is unnecessary to provide a specific attachment means in the electronic cassette 12. This contributes to simple configuration. The base locking mechanism 30 can have an arbitrary configuration as long as it prevents the base column 26 from slipping off from the opening 24a. The base locking mechanism 30 may be constituted of a lock hole, a lock pin flexibly insertable into the lock hole, and a lock pin thrust mechanism.

Also, the holder arm 13 holds the arm body 25 movably in the vertical direction, for ease of adjustment in the height of the X-ray source 17. The attachment pipe 27 can be flexibly pulled from and retracted into the horizontal portion 25b of the arm body 25, for ease of adjustment in the horizontal position of the X-ray source 17. The holder arm 13 for moving and shifting the X-ray source 17 is used in the positioning between the body part and the X-ray source 17 and in the position change of the X-ray source 17 in the stereoscopic radiography mode, as described above. Particularly, the holder arm 13 is also useful in a case where the electronic cassette 12 is exchanged with another one having the incident surface 12a of the different size. The size of the irradiation field has to be changed in accordance with the size of the incident surface 12a of the electronic cassette 12. In this case, adjustment of the height of the X-ray source 17 brings about change of the SID, and change in the size of the irradiation field. Also, the position of the center of the incident surface 12a is changed in accordance with the size of the incident surface 12a of the electronic cassette 12, because the holder arm 13 is attached to a side of the case 12b of the electronic cassette 12. In this case, the X-ray source 17 is moved in the horizontal direction via the attachment pipe 27.

In the first embodiment, only one base position BP is prepared. Plural base positions BP may be prepared instead in accordance with plurality types of electronic cassettes 12 having an incident surface 12a of different sizes. The click stopper 37 preferably works at each base position BP for ease of the positioning, even if the size of the electronic cassette 12 is changed.

### Second Embodiment

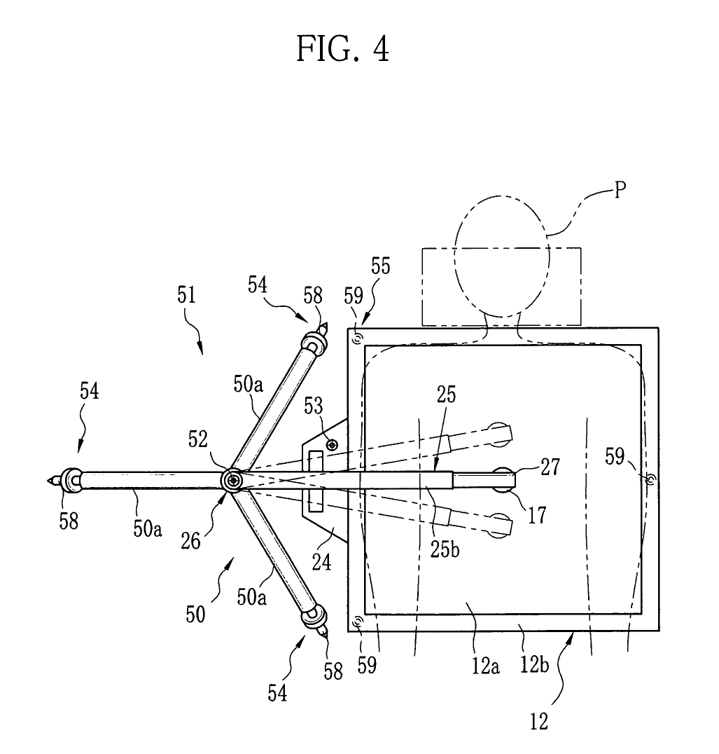

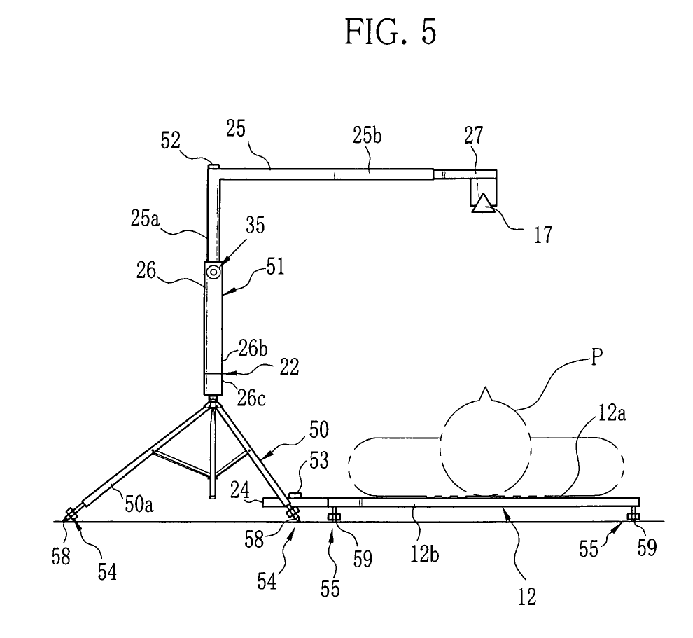

In the first embodiment, the fitting portion 26a of the base column 26 is fitted into the opening 24a of the grip 24 of the electronic cassette 12 to integrate the holder arm 13 with the electronic cassette 12. However, as shown in FIGS. 4 and 5, the base column 26 may be provided with a tripod to dispose the X-ray source 17 separately from the electronic cassette 12. In this case, the electronic cassette 12 and the X-ray source 17 are not integrated through the holder arm 13, in contrast to the first embodiment. Thus, a holder arm 51 and the electronic cassette 12 are provided with levels 52 and 53 and level adjusters 54 and 55, respectively, to parallel a shift plane of the X-ray source 17 with the incident surface 12a of the electronic cassette 12. Note that, in each of the following embodiments, the same reference numerals as those of the first embodiment will denote components the same as or similar to those of the first embodiment, and description thereof will be omitted.

The level 52 of the holder arm 51 is disposed on a top surface of the arm body 25, for example. The level 53 of the electronic cassette 12 is disposed on the grip 24. The level adjuster 54 of the holder arm 51 includes adjustment bolts 58 disposed at a bottom end of each leg 50a of a tripod 50. The level adjuster of the electronic cassette 12 includes at least three adjustment bolts 59 disposed on a bottom surface of the case 12b. To make the shift plane of the arm body 25 and the incident surface 12a horizontal, each adjustment bolt 58, 59 is turned with looking at the level 52, 53. If both of the shift plane of the arm body 25 and the incident surface 12a are horizontal, the shift plane is made in parallel with the incident surface 12a, and the R and L viewpoint images are obtained with keeping the SID at constant. Note that, the case 12b may be provided with a bracket for fixing the positions of the two legs 50a of the tripod 50, for ease of positioning of the holder arm 51 relative to the electronic cassette 12.

The levels 52, 53 and the level adjusters 54, 55 are not limited to those shown in FIGS. 4 and 5, and may have various configurations as long as they can make the arm body 25 and the incident surface 12a horizontal.

### Third Embodiment

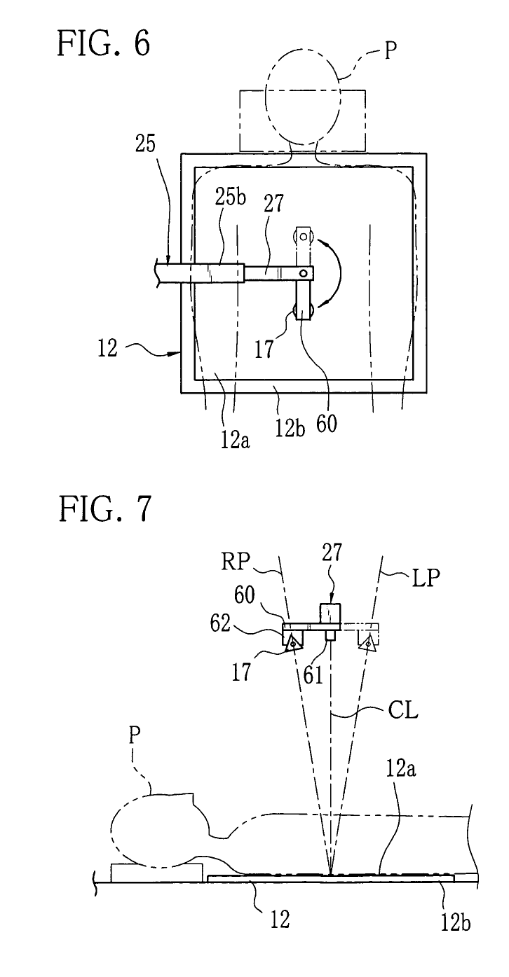

As shown in FIGS. 6 and 7, the X-ray imaging system 10 according to this embodiment is provided with a turning arm 60, which is turnable at an angle of 180° above the center of the incident plane 12a of the electronic cassette 12 around a vertical line passing through the center of the incident surface 12a. At this time, as shown in FIG. 7, a laser pointer 61 is provided on the turning arm 60 at a position in a rotation center line CL. The position of the arm body 25 is determined such that a point directed by the pointer 61 coincides with the center of the incident surface 12a. The base column may be either of a fitting type as shown in FIG. 1 or of a tripod type as shown in FIG. 4. Note that, the fitting type of base column is convenient to the positioning because all the operator has to do is fit the base column into the opening of the grip.

The X-ray source 17 is attached to the turning arm 60 via an inclination mechanism 62. A pivot of the turning arm 60 is positioned directly above the center of the incident surface 12a. Thus, if an inclination angle of the inclination mechanism 62 is adjusted at either of the R and L irradiation positions RP and LP, it is unnecessary to readjust the inclination angle at the other position after a turn by 180°. This allows the easy adjustment of the inclination angle. Not only the SID, but also the inclination angle from the X-ray source 17 to the incident surface 12a is the same at both the R and L irradiation positions RP and LP. Therefore, the obtained stereo image becomes natural and realistic. In this embodiment, the operator easily detect at first sight which irradiation position the X-ray source 17 is situated, because the turning arm 60 changes its position by a turn of 180°. Inclining the X-ray source 17 shortens the distance between the R and L irradiation positions RP and LP (the length of the turning arm 60), and additionally, increases an overlap of the irradiation fields of the R and L irradiation positions RP and LP, resulting in increase in an area observable by the stereoscopy.

### Fourth Embodiment

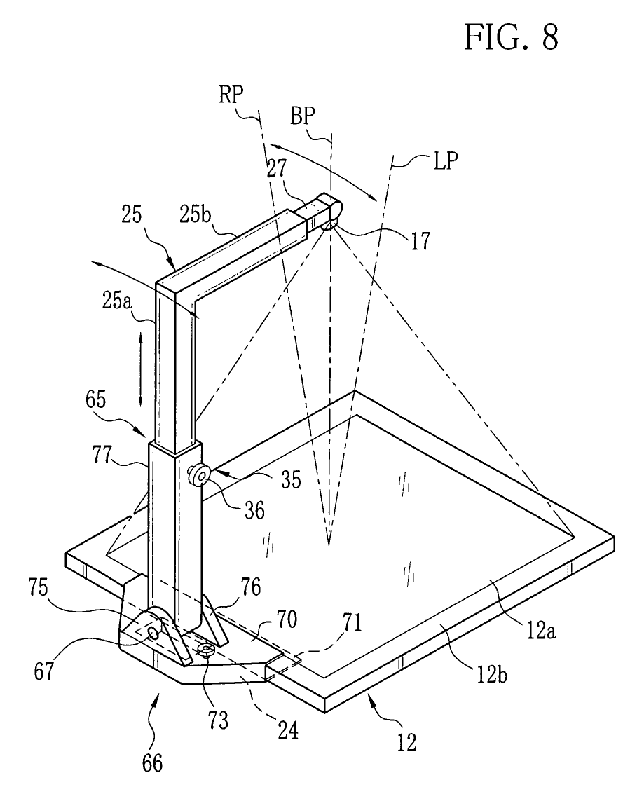

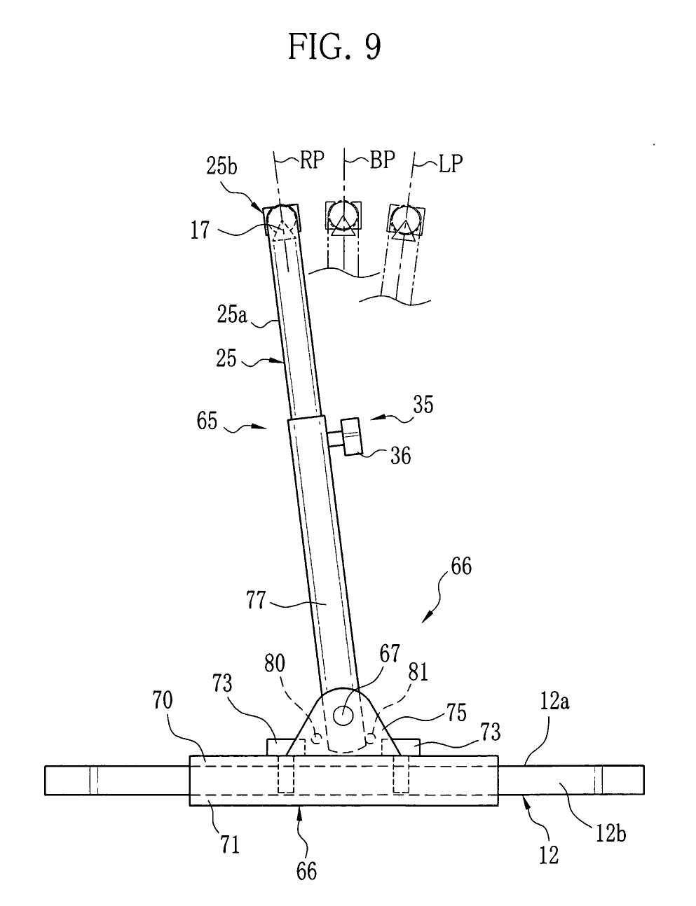

In this embodiment, as shown in FIGS. 8 and 9, a bracket 66 is provided at a bottom end of a holder arm 65 via a swing shaft 67. The bracket 66 is attached over the grip 24 of the electronic cassette 12 and a margin of the case 12b. This configuration allows the holder arm 65 to swing about the swing shaft 67 in a plane orthogonal to the incident surface 12a.

The bracket 66 has two catching plates 70 and 71, which catch from above and below the grip 24 of the electronic cassette 12 and the margin of the case 12b. The bracket 66 is fixed on the grip 24 with lock screws 73. Note that, the bracket 66 may be fixed on the electronic cassette 12 with an engagement mechanism, instead of the lock screws 73.

On the bracket 66, a pair of hold boards 75 and 76 is erected to catch a base column 77 between the hold boards 75 and 76. The swing shaft 67 penetrates the base column 77 and the hold boards 75 and 76 in the horizontal direction.

As shown in FIG. 9, stoppers 80 and 81 are provided on an inner surface of the hold board 75 or 76 to regulate a swing of the holder arm 65. The stoppers 80 and 81 situate the holder arm 65 at the R and L irradiation positions RP and LP, respectively. The stoppers 80 and 81 may be provided with a fine adjustment mechanism, for use in fine adjustment of each R or L irradiation position RP or LP concentrically about the swing shaft 67.

Between the base column 77 and the hold board 75 or 76, a not-shown click stop mechanism or friction stop mechanism is provided. The click or friction stop mechanism fixes the X-ray source 17 at the base position BP, being the midpoint between the R and L irradiation positions RP and LP. Note that, the X-ray source 17 may be fixed at the R and L irradiation positions RP and LP by the click or friction stop mechanism, instead of or in addition to using the stoppers 80 and 81.

According to this embodiment, the X-ray source 17 is easily set at the R or L irradiation position RP or LP by the swing motion of the holder arm 65 in the plane orthogonal to the incident surface 12a. Additionally, when the X-ray source 17 is situated in the base position BP, the center of the irradiation field of the X-ray source 17 coincides with the center of the imaging section 40 of the electronic cassette 12. As an additional plus, a center of the swing motion of the holder arm 65 is situated in the vicinity of the imaging section 40. For this reason, the center of the irradiation field of the X-ray source 17 is always positioned approximately at the center of the imaging section 40, even if the holder arm 65 is set at any swing position. This eliminates the need for adjusting the inclination angle of the X-ray source 17. Note that, if the center of the swing motion of the holder arm 65, that is, the center of the swing shaft 67 is disposed in a horizontal plane containing the incident surface 12a, the center of the irradiation field of the X-ray source 17 always coincides with the center of the incident surface 12a irrespective of change in a swing angle of the holder arm 65.

In each of the above embodiments, the X-ray source 17 is detachably attached to the holder arm 13, 51, or 65, but may be fixed thereon. However, in the case of detachably attaching the X-ray source 17 to the holder arm 13, 51, or 65, an optimal X-ray source is selectable in accordance with the location where the X-ray imaging system 10 is carried along and the patient's body part to be imaged. Thus, the X-ray imaging system 10 becomes more easily available for the stereoscopic radiography in various situations. As the X-ray source 17, a conventionally existing X-ray source is available. In this case, a commodity product to be sold may exclude the X-ray source, and includes only a combination of the electronic cassette and the holder arm having an attachment portion for detachably attaching the X-ray source.

In the above embodiments, the arm body 25 is in the shape of the letter L, but the shape of the arm body 25 is not limited to it as long as it can hold the X-ray source 17. The arm body 25 may be curved into an arc shape, for example. The number of the base column is not limited to one, but may be two or more. In this case, each base column may be detachably attached to the electronic cassette 12.

In the above embodiment, the X-rays are used as radiation. However, the present invention is applicable to an imaging system using another type of radiation such as y-rays.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A portable radiation imaging system comprising:
a radiation source for applying radiation to an object;
a portable electronic cassette having a radiation image detector and a case for containing said radiation image detector, said case being formed with an incident surface upon which said radiation is incident, said radiation image detector detecting a radiographic image of said object upon reception of said radiation that is passed through said object and is incident upon said incident surface of said case;
a portable holder arm for holding said radiation source such that said radiation source is opposed to said incident surface, and for shifting said radiation source between an R irradiation position and an L irradiation position, a pair of R viewpoint image and L viewpoint image having a stereoscopic parallax being obtained with a shift of said radiation source between said R and L irradiation positions; and
a positioning mechanism for fixing said radiation source at said R and L irradiation positions.

2. The portable radiation imaging system according to claim 1,
wherein said portable holder arm has an arm body and a base column, and said radiation source is attached to said arm body, and said arm body is movably attached to said base column, and said radiation source is selectively shifted between said R and L irradiation positions by a motion of said arm body; and
wherein said positioning mechanism regulates said motion of said arm body to fix a position of said radiation source.

3. The portable radiation imaging system according to claim 2, wherein said arm body pivots about its one end opposite to the other end having said radiation source attached thereto, in a plane parallel with said incident surface, in order to shift said radiation source between said R and L radiation positions.

4. The portable radiation imaging system according to claim 3,
wherein in said arm body, a length between said end functioning as a pivot and an attachment position of said radiation source is a half of said stereoscopic parallax; and
wherein when said arm body turns by 180 degrees, said radiation source is shifted from one of said R and L irradiation positions to the other.

5. The portable radiation imaging system according to claim 4, wherein said arm body has an inclination mechanism for attaching said radiation source in such a manner that a radiation emission direction is inclined toward said pivot.

6. The portable radiation imaging system according to claim 1,
wherein said portable holder arm has an arm body and a base column, and said radiation source is attached to one end of said arm body, and said base column is coupled to the other end of said arm body, and said base column is disposed near said portable electronic cassette and swings in a plane orthogonal to said incident surface; and
wherein said positioning mechanism regulates a swing of said base column to fix a position of said radiation source.

7. The portable radiation imaging system according to claim 1, wherein said positioning mechanism fixes said radiation source at a base position being a midpoint between said R and L irradiation positions.

8. The portable radiation imaging system according to claim 1, wherein said portable holder arm includes:
a height adjusting mechanism for adjusting a height of said radiation source from said incident surface; and
a horizontal position adjusting mechanism for adjusting a position of said radiation source in a direction parallel with said incident surface.

9. The portable radiation imaging system according to claim 1, wherein said portable holder arm is detachably attached to said case.

10. The portable radiation imaging system according to claim 1, wherein said portable holder arm includes a tripod.

11. The portable radiation imaging system according to claim 10, further comprising:
a level provided on each of said portable holder arm and said case;
a tripod level adjuster provided in said tripod to adjust a posture of said tripod such that said radiation source is coplanar and horizontal at said R and L irradiation positions; and
a case level adjuster provided in said case to adjust a posture of said case such that said incident surface is horizontal without wobbling.

12. A portable radiation imaging system comprising:
a portable electronic cassette having a radiation image detector and a case for containing said radiation image detector, said case being formed with an incident surface upon which radiation is incident, said radiation image detector detecting a radiographic image of said object upon reception of said radiation that is emitted from a radiation source and passed through said object and incident upon said incident surface of said case;
a portable holder arm for holding said radiation source such that said radiation source is opposed to said incident surface, and for shifting said radiation source between an R irradiation position and an L irradiation position, a pair of R viewpoint image and L viewpoint image having a stereoscopic parallax being obtained with a shift of said radiation source between said R and L irradiation positions; and
a positioning mechanism for fixing said radiation source at said R and L irradiation positions.

13. The portable radiation imaging system according to claim 12, wherein said radiation source is detachably attached to said portable holder arm.
